(19) United States
(12) Patent Application Publication
(10) Pub. No.: US 2017/0314591 A1
(43) Pub. Date: Nov. 2, 2017

(54) Spring loaded split tongue connector system

(71) Applicant: Geoffrey Alan Baker, Sandisfield, MA (US)

(72) Inventor: Geoffrey Alan Baker, Sandisfield, MA (US)

(21) Appl. No.: 14/999,348

(22) Filed: Apr. 28, 2016

(51) Int. Cl. F16B 5/00; F16B 11/00

(52) U.S. Cl. CPC F16B 5/002; F16B 11/006; E04F 2201/0115

(57) ABSTRACT

A connector system for mechanically connecting two structural elements to each other, consisting of a connector element and mating grooves in each structural element. The connector element is comprised of a base plate having a split-tongue element at each side or end of said base plate. Each joined element has a mating groove formed into its connector-receiving surface. The mating groove is designed to allow fabrication via four sequential circular saw cuts, without loss of saleable decorative surface, and at a rate consistent with economical commercial production of vinyl, laminate, or hardwood flooring. The connector element is readily extruded in a variety of polymers, including PVC. The connector and mating grooves interact so as to generate a force component acting to forcibly draw the connector into the mating grooves. The connector system operation is relatively insensitive to geometric deviations associated with normal manufacturing methods.

### BACKGROUND OF INVENTION

### Field of Invention

This invention is a CIP application that claims priority to U.S. Pat. No. 9,322,421 filed on Mar. 9, 2015. This invention relates to a connector system for mechanically joining building panels (such as vinyl, laminate, or hardwood flooring); mechanically attaching decorative items (such as wall panels, ceiling panels, or automotive trim); mechanically attaching subsystems (such as automotive dashboards; or mechanically connecting elements of ready-to-assemble furniture.

### Prior Art

The connector system describe in U.S. Pat. No. 9,322,421, herein referred to as the “prior patent”, is treated as prior art and provides the basis for the present inventive connector modifications. FIGS. 1 to 4 describe this prior art and restate the terminology that is used in that patent and that is carried over to the present continuation-in-part application.

FIG. 1 shows the normal embodiment of the connector system as taught in the prior patent and as used to connect hardwood flooring. The upper detail shows the connector system prior to assembly, and the lower detail shows the assembled system wherein the two floor board elements are mechanically joined by the connector. The arrows 119 and 120 in the upper figure show the direction in which the joined elements move relative to the connector during assembly. The descriptor “normal” in this embodiment indicates that the motion of the connector relative the floor boards is normal to the flat upper surfaces of the boards.

In FIG. 1, items 1 and 3 a first and second floor board respectively, and items 2 and 4 are their respective decorative surfaces. Item 31 is a normal connector element having a first split-tongue 33 and second split-tongue 36. The two split-tongues 33 and 36 are supported by base plate 32. Said base plate 32 has a first extension 55 and a second extension 56. The first split-tongue 33 has two flexible arms 34 and 35 respectively, and the second split-tongue 36 has two flexible arms 37 and 38 respectively. The flexible arms 34, 35, 37, and 38 have outward facing nubs 98, 99, 100, and 101 respectively at their distal ends. The first split-tongue 33 mates with the mating groove 39 in the first floor board 1, and the second split-tongue 36 mates with the mating groove 40 in the second floor board 3.

In FIG. 1, the first base plate extensions 55 is received by inner recess region 118 as the first floor board 1 is moved in the direction of first assembly arrow 120 during connector system assembly. Similarly, the second base plate extensions 56 is received by inner recess region 48 as the second floor board 2 is moved in the direction of second assembly arrow 119 during connector system assembly. .In FIG. 1, the base plate 32 provides vertical support for those portions 108 and 109 that overhang the normal connector.

FIG. 2 shows the lateral embodiment of the connector system as taught in the prior patent and as used to connect hardwood flooring. The upper detail shows the connector system prior to assembly, and the lower detail shows the assembled system wherein the two floor board elements are mechanically joined by the connector. The arrows 115 and 116 in the upper figure show the direction in which the joined elements move relative to the connector during assembly. The descriptor “lateral” in this embodiment indicates that the assembly motion is in a lateral direction, i.e., parallel to the flat upper surfaces of the floor boards and normal to the joined faces.

In FIG. 2, items 1 and 3 are first and second floor boards respectively, and items 2 and 4 are their respective decorative surfaces. Item 17 is a lateral connector element having one split-tongue element 18 and a second split-tongue element 19. The two split-tongues 18 and 19 are formed on either side of base plate 20. Split-tongue 18 has two flexible arms 21 and 22, and split-tongue 19 has two flexible arms 23 and 24. The flexible arms 21, 22, 23, and 24 have outward facing nubs 41, 42, 43, and 44 respectively at their distal ends. Split-tongue 18 mates with groove 25 in floor board 1 and split-tongue 19 mates with groove 26 in floor board 3. Said nubs 41 and 42 contact the side-walls of said mating groove 25 of said split-tongue 18; and said nubs 43 and 44 contact the side-walls of the said mating groove 26 of said split-tongue 19.

In FIG. 2, the first and second sides of upper base plate extension 45 are received by recess regions 113 and 59 as the first and second floor boards 1 and 2 are moved in the direction of the arrows 115 and 116 during connector system assembly. Similarly, the first and second sides of lower base plate extension 46 are received by recess regions 114 and 60 as the first and second floor boards 1 and 2 are moved in the direction of the arrows 115 and 116 during connector system assembly. The base plate extensions 45 and 46 of base plate 20 provide vertical structural support to floor board portions 28 and 29 that overhang the connector in FIG. 2. The mating groove design for the normal connector, item 31 in FIG. 1, is shown in FIG. 3. The groove is fabricated into the connector-receiving surface opposite the decorated surface 4 of second floor board 3. The groove consists of five regions arranged sequentially in the direction 30 of tongue insertion into the groove. The first region is a recess region defined by recess upper surfaces 47 and 48. The upper surface 47 of the recess region receives the normal connector base plate 32 and upper surface 48 is receives the base plate extension 56 in FIG. 5. The recess region is followed by an entry region defined by converging sidewalls 49 and 50; an apex region defined by minimum groove width points 51 and 52; a hold region defined by diverging sidewalls 53 and 54; and groove cap or termination region defined by surfaces 57 and 58 and by triangular element 63. The groove sidewall angles are defined as follows: angles 102 and 103 are the first and second entry region convergence angles respectively; and angles 104 and 105 are the first and second hold region divergence angles respectively. The triangular element 63 is part of the groove cap and it may be kept in place or it may be removed with no impact on the operation of the connector system.

In FIG. 2, first mating groove 25 in the first concrete block 130 mates with first split-tongue element 18 of lateral connector, item 17. The first mating groove 25 shown is comprised of four regions arranged sequentially in the direction 30 of tongue insertion into the groove. These regions are: a recess region defined by recess upper surfaces 59 and 60 to accept base plate extensions 45 and 46 in FIG. 4; an entry region defined by converging sidewalls 49 and 50; an apex region defined by minimum groove width points 51 and 52; a hold region defined by diverging sidewalls 53 and 54, and groove cap or termination region 57 and 58, and by triangular element 63. The groove sidewall angles are defined as follows: angles 102 and 103 are the first and second entry region convergence angles respectively; and angles 104 and 105 are the first and second hold region divergence angles respectively. The triangular element 63 is part of the groove cap and it may be kept in place or it may be removed with no impact on the operation of the connector system

In FIG. 3, items 49, 51, and 53 form the second sidewall and items 50, 52 and 54 form the first sidewall of its groove. Similarly, in FIG. 4, items 49, 51, and 53 form the second sidewall and items 50, 52 and 54 form the first sidewall of its groove.

In FIG. 1, the base plate 32 provides vertical support for those portions 108 and 109 that overhang the normal connector. Base plate 32, in conjunction with base plate extensions 55 and 56 in FIG. 1, act to limit the extent to which the split-tongue can be drawn into its mating groove and, hence, set the location of the fully inserted split-tongue past the apex and the associated residual split-tongue arm deflection.

In FIG. 2, the base plate extensions 45 and 46 of base plate 20 serve two functions:
1. limit the extent to which the split-tongue can be drawn into the groove and, hence, set the location of the fully inserted split-tongue past the apex and the associated residual split-tongue arm deflection,
2. provide vertical structural support to those portions 28 and 29 of the floor boards that overhang the connector in FIG. 2.

During connector element insertion into its mating groove, the outward facing nubs on the flexible arms contact the converging walls of the mating groove entry region causing the arms to bend or deflect inward. The maximum deflection occurs when the arm nubs reach the groove apex. The maximum arm bending stress occurs this point, and consequently, the groove minimum width at the apex is selected to avoid significant plastic deformation of the flexible arms as they pass the groove apex during split-tongue insertion.

Continued insertion of the tongue past the groove apex causes the nubs to contact the diverging walls of the hold region and the associated arm deflection to decrease. The connector becomes fully inserted into its mating groove when the base plate 32 and its extension 56 in FIG. 5 rest on the groove upper recess surfaces 47 and 48 in FIG. 3. The residual arm deflection, i.e., the split-tongue arm deflection at full insertion, though less than that maximum arm deflection associated with the nubs at the groove apex, is significantly not zero.

### SUMMARY OF INVENTION

The present invention describes the manner in which the base plate 32 and first and second base plate extensions 55 and 56 respectively of normal connector 31 in FIG. 1 can be used in conjunction with mating groove recess regions 47, 48, 117 and 188 to accommodate variations in flooring thickness variations due to manufacturing tolerances.

The invention addresses the fact that in cases where the flooring thickness manufacturing tolerances are reduced to the point that acceptable planar flatness of the upper decorative surfaces 2 and 4 of floor boards 1 and 3 respectively in FIG. 1 can be maintained without special accommodation, the recess distance 122 in FIG. 3 can be reduced to zero, essentially eliminating the recess region from the groove geometry.

The invention addresses the fact that in a lateral split-tongue connector system, elimination of the mating groove recess regions allows the lateral connector to be employed to stack concrete blocks while avoiding direct block-to-block contact with the attendant potential for block mechanical failure

The invention addresses alternate mechanical means of attaching a lateral split-tongue connector to solid entity or attaching a normal split-tongue connector element to a floor board.

### BRIEF DESCRIPTION OF DRAWINGS

Other aspects, features, and advantages of the present invention will become more fully apparent from the following detailed description, the appended claims, and the accompanying drawings in which similar element are given similar reference numerals.

FIG. 1 is a side view showing assembled and disassembled views of the normal connector system disclosed in the prior patent

FIG. 2 is a side view showing assembled and disassembled views of the lateral connector system disclosed in the prior patent

FIG. 3 shows the mating groove for a normal connector shown in FIG. 1 and as disclosed in the prior patent.

FIG. 4 show the mating groove for a lateral connector shown in FIG. 2 as disclosed in the prior patent.

FIG. 5 shows the manner in which the recess groove can be made to accommodate the large variations in floor board thickness due to manufacturing tolerances.

FIG. 6 shows a lateral connector element used to connect two concrete blocks

FIG. 7 shows a half lateral connector attached permanently to a first solid entity by a staple and a second solid entity attached temporarily to the half lateral connector via a single split-tongue that interacts with a mating groove in the second solid entity.

FIG. 8 shows a half lateral connector attached permanently to a first solid entity by means of a stud glued into a rectangular groove, and a second solid entity attached temporarily to the half lateral connector via single split-tongue that interacts with a mating groove in the second solid entity.

FIG. 9 shows a half normal connector attached permanently to a first solid entity by means of a stud glued into a rectangular groove, and a second solid entity attached temporarily to the half lateral connector via single split-tongue that interacts with a mating groove in the second solid entity.

FIG. 10 shows a half normal connector attached semi-permanently to a first solid entity by means of a finned protrusion.

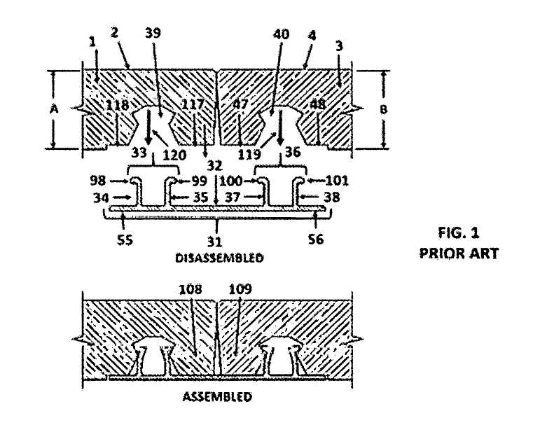

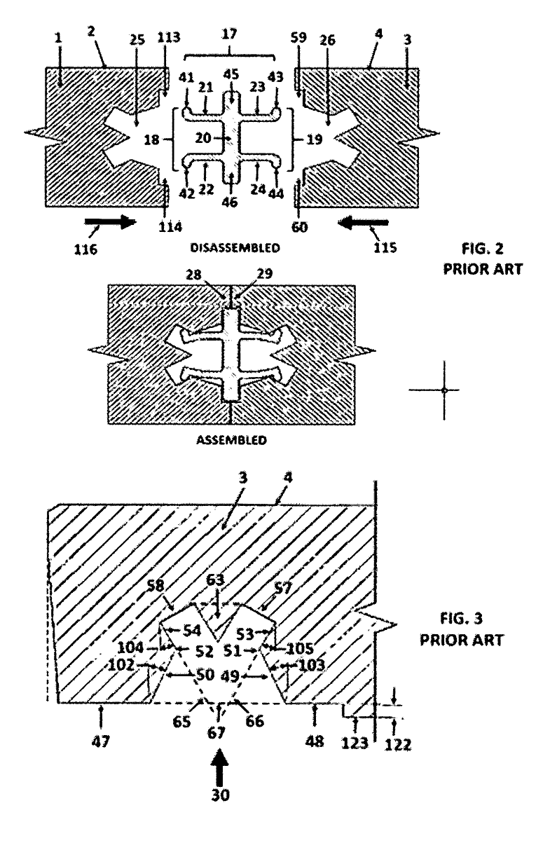

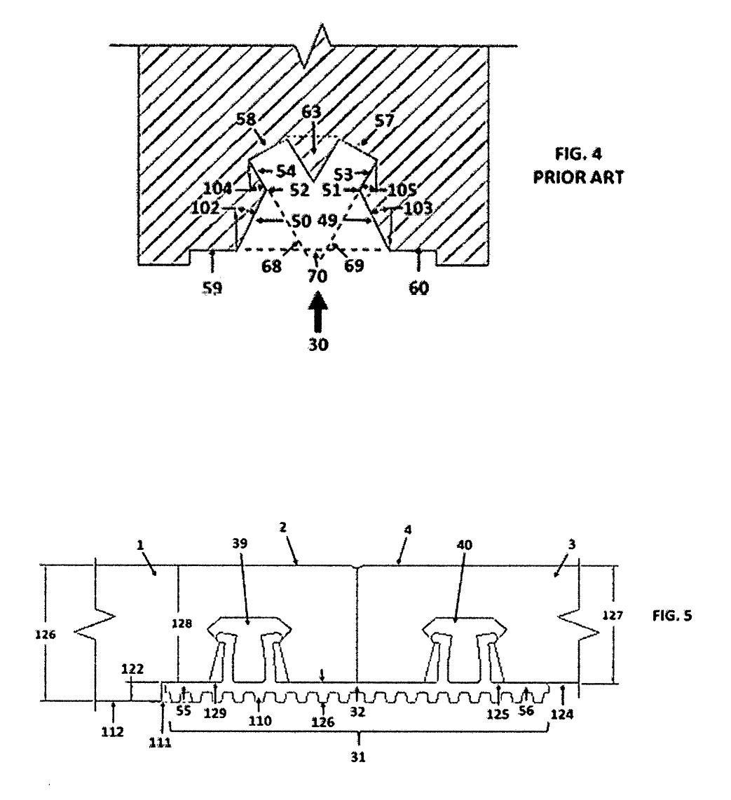

### DESCRIPTION OF PREFERRED EMBODIMENTS

The invention disclosed in U.S. Pat. No. 9,322,421 recognizes the fact that the normal groove recess regions 47 and 48 in FIG. 3 can be used to allow the normal connector in FIG. 1 to vertically align decorative surfaces 3 and 4 of flooring elements 1 and 2 in FIG. 1, when the thickness of the flooring elements differ significantly from each other due to manufacturing tolerances.

FIG. 5 shows a case in which the height 126 of first flooring element 1 is significantly greater than the height 127 of second flooring element 3. Should these flooring elements rest directly on a flat underlying substrate, this difference in floor heights would result in an unacceptable non-planar alignment of the decorative surfaces of the two flooring elements.

To avoid this condition, the flooring elements are made to rest indirectly on the underlying planar substrate through the intermediate action of the normal connector element, and with the geometry of the normal connector element and its mating split-tongue groove being modified so as to accommodate the difference in flooring height so that the decorative surfaces are brought into planar alignment.

In FIG. 5, the lower surface 124 of flooring element 3 with the smaller vertical height 127 is made congruent with the upper surface 125 of the first base support extension 56. To bring the decorative surface 2 of flooring element 1 into vertical alignment with decorative surface 4 of flooring element 3, recess vertical dimension 128 of flooring element 1 must be made essentially equal in value to vertical height dimension 127.

The recess distance 122 of first side flooring element 1 is equal to the difference between the vertical height 126 of flooring element 1 and vertical height 127 of flooring element 3. In order for the both flooring elements 1 and 3 to be supported of the underlying substrate via connector element 31, the thickness 126 of the base support 32 and first and second base support extensions 55 and 56 respectively must be greater than the recess distance 122.

When this condition is met, then the lower surface 111 of normal connector element 31 will be below the lower surface 112 of first floor element 1 and below the lower surface 124 of flooring element 124. Consequently, only the lower surface 111 of normal connector 31 will be in direct contact with the underlying support substrate.

It should be noted in FIG. 5 that multiple nubs 110 have been added to the underside of base support 32 and first and second base support extensions 55 and 56 to increase the vertical thickness 126 of these elements. Since the magnitude of vertical distance 126 determines the maximum vertical difference in flooring heights 126 and 127 that can be accommodated by normal connector 31, these nubs serve to increase the height difference that can be accommodated.

The vertical height 126 is increased using multiple nubs for two reasons: 1) to reduce the cross sectional area of the connector and, hence its material cost, by eliminating the material that would be contained in the spaces between the nubs; and 2) to maintain and essentially constant material thickness over the connector cross section in order to simplify the extrusion die design.

The embodiment shown in FIG. 5 addresses the case in which the difference in vertical height between flooring elements due to manufacturing tolerances is large. In that case the recess region of the groove of the flooring element with the smaller height is eliminated and the recess region of the flooring element with the larger vertical height is made as small as can be consistent while still accommodating the large difference in flooring height.

In the case in which the vertical height difference between flooring elements is small, the recess region can be eliminated from both flooring elements as long as the height difference is small enough so that the extent to which the decorative surface of the larger flooring element extends above that of the smaller flooring element is deemed to be acceptable.

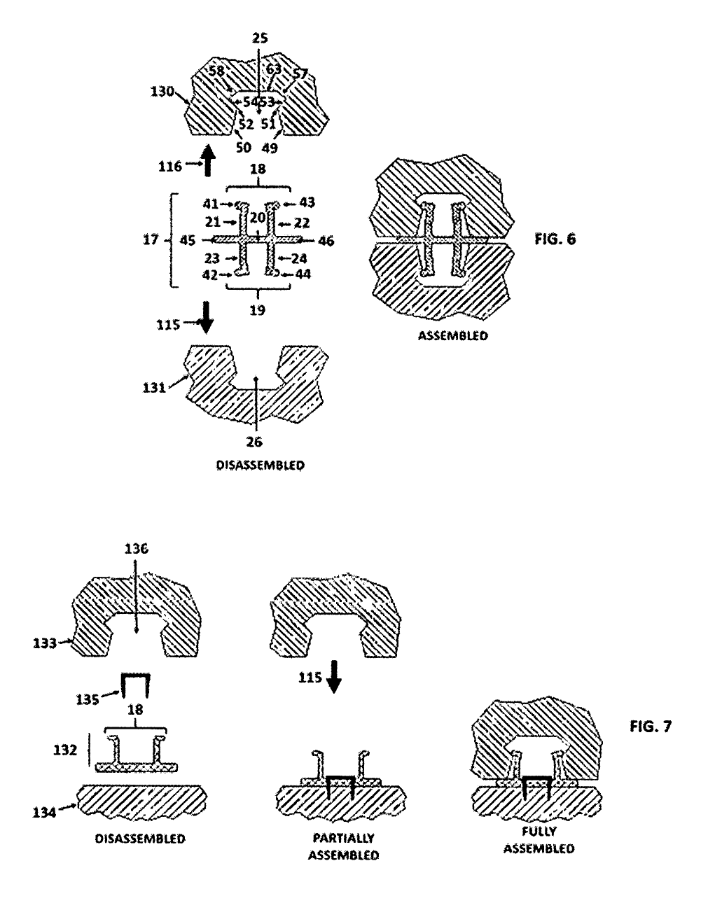

FIG. 6 shows a lateral connector used to connect two concrete blocks in the disassembled and assembled condition. Items 130 and 131 are first and second concrete blocks respectively; and associated lateral connector 17 has a first split-tongue element 18 and a second split-tongue element 19. The two split-tongues 18 and 19 are formed on either side of base plate 20. First split-tongue 18 has two flexible arms 21 and 22, and second split-tongue 19 has two flexible arms 23 and 24. The flexible arms 21, 22, 23, and 24 have outward facing nubs 41, 42, 43, and 44 respectively at their distal ends. First split-tongue 18 mates with groove 25 in concrete block 130 and second split-tongue 19 mates with groove 26 in concrete block 131. Said nubs 41 and 42 contact the side-walls of said mating groove 25 of said split-tongue 18; and said nubs 43 and 44 contact the side-walls of the said mating groove 26 of said split-tongue 19.

In FIG. 6, the mating groove 25 of first concrete block 130 mates with first split-tongue 18 of lateral connector 17. The groove is comprised of four regions arranged sequentially in the direction 116 of first split-tongue 18 into mating groove 25. These regions are: an entry region defined by converging sidewalls 49 and 50; an apex region defined by minimum groove width points 51 and 52; a hold region defined by diverging sidewalls 53 and 54, and groove cap or termination region 57, 58, and 63. The mating groove 26 of second concrete block 131 mates with the second split-tongue 19 of lateral connector 17. The geometry of mating groove 26 is similar to that of mating groove 25 and consists of the same four regions arranged sequentially in the direction 115 of insertion of second split-tongue 19 into the groove. In the assembled condition, the first and second base extensions 45 and 46 serve to prevent direct concrete block to concrete block contact.

FIG. 7 shows a half lateral connector 132 with a single split tongue element 18 used to temporarily connect first solid entity 133 to second solid entity 134. The half solid lateral connector is permanently attached to the second solid entity via staple 135. The first solid entity is attached temporarily to the half lateral connector via the interaction of the nubs 41 and 43 on the distal ends of flexible arms 21 and 22 with the side walls 137 of mating groove 136.

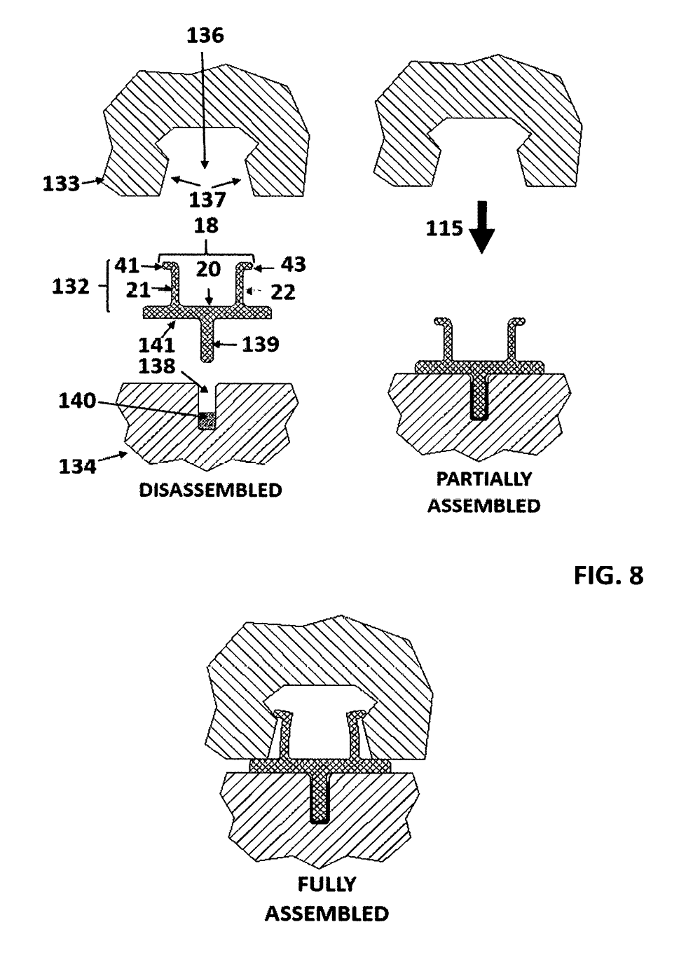

FIG. 8 shows a half lateral connector 132 with a single split tongue element 18 used to temporarily connect first solid entity 133 to second solid entity 134. The half solid lateral connector has a slab-like stub 139 protruding from the lower surface 141 of its base support 20. The slab-like stub is received by rectangular groove 138. In the disassembled condition and just prior to partial assembly, a small quantity of liquid adhesive 140 is introduced into rectangular groove 138.

During partial assembly, half lateral connector 132 is permanently attached to second solid entity 134 by moving the half lateral connector in the direction of arrow 115 so that the slab-like stub enters into rectangular groove 138 causing liquid adhesive a40 to flow into the clearance gap between the sides of the rectangular groove and the sides of the slab-like stub. Hardening of the liquid adhesive then permanently bond the half lateral connector to the second solid entity. The first solid entity is attached temporarily to the half lateral connector via the interaction of the nubs 41 and 43 on the distal ends of flexible arms 21 and 22 with the side walls 137 of mating groove 136.

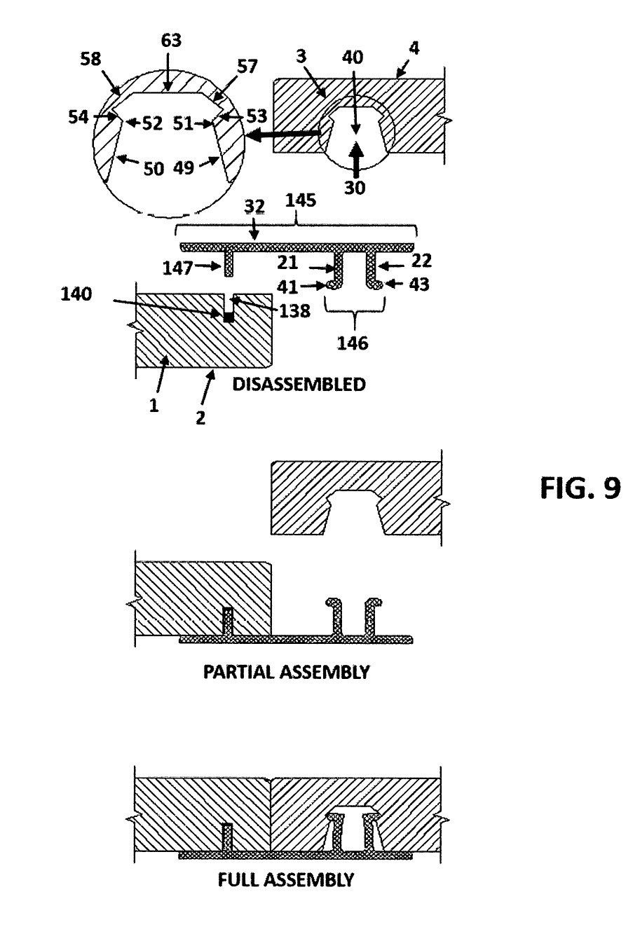

FIG. 9 shows a half normal connector 145 with a single split-tongue 146 protruding from base support 32, said single split-tongue having first and second flexible arms 21 and 22 with nubs 41 and 43 protruding in an outward facing direction from the distal end of each flexible arm respectively. The base plate has slab-like element 147 protruding from the location on support arm 32 where the second split-tongue 33 of normal connector 31 in FIG. 1 would be located, and protruding in the same direction as said single split-tongue.

First flooring element 1 with decorative surface 2 has rectangular groove 138 cut into the side of the board opposite said decorative surface. Prior to partial assembly, liquid adhesive 140 is place in said rectangular groove. During partial assembly, slab-like protrusion 147 is made to enter said rectangular groove so as to displacer said liquid adhesive into contact with the sides of said rectangular groove and said slab-like protrusion. After the liquid adhesive hardens, said slab-like protrusion and its monolithic half normal connector is permanently attached to said rectangular groove and said first flooring element into which it is cut.

In FIG. 9, second flooring element 3 with decorative surface 4 has groove 40 cut into the side of the hoard opposite the decorative surface. Groove 40 contains four elements arranged sequentially in the direction 30 of split-tongue entry into said groove: a converging entry region defined by sidewalls 49 and 50; a minimum width apex region defined by side wall elements 51 and 52; a diverging region defined by sidewalls 53 and 54; and a cap region defined by elements 57, 58 and 63.

In FIG. 9, during full assembly, single split-tongue 146 on half normal connector 145 mates with groove 40 in second floor board 3 to connect floor boards 1 and 3.

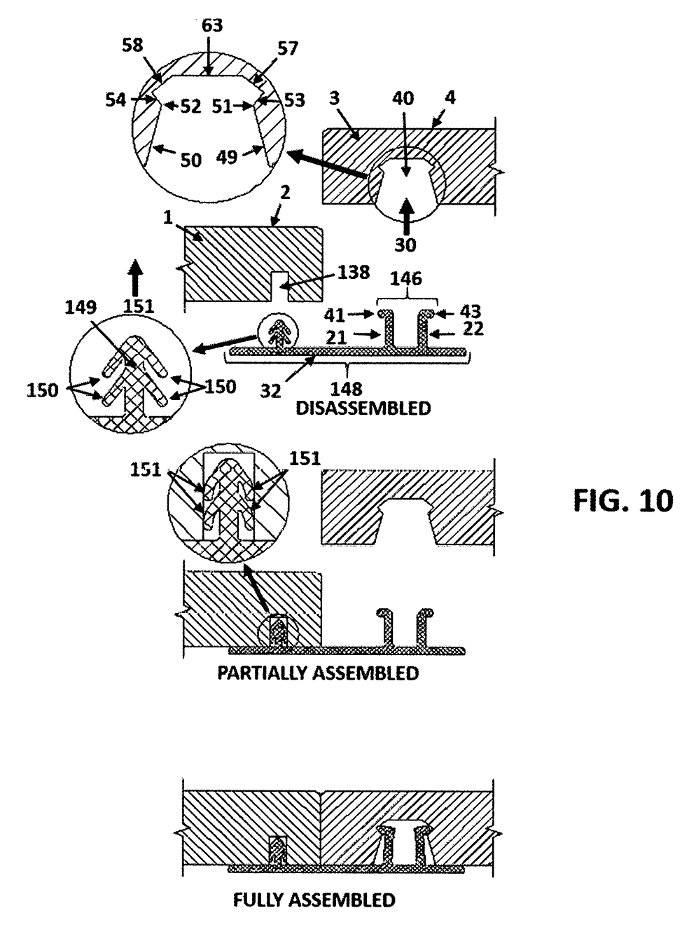

FIG. 10 shows a half normal connector 148 with a single split-tongue 146 protruding from base support 32, said single split-tongue having first and second flexible arms 21 and 22 with nubs 41 and 43 protruding in an outward facing direction from the distal end of each flexible arm respectively. The base plate has slab-like element 149 protruding from the location on support arm 32 where the second split-tongue 33 of normal connector 31 in FIG. 1 would be located, and protruding in the same direction as said single split-tongue.

In FIG. 10, first flooring element 1 with decorative surface 2 has rectangular groove 138 cut into the side of the board opposite said decorative surface. Slab-like protrusion 149 has fin-like elements 150 protruding from its two sides, said fin-like protrusions being canted back in direction opposite the direction of insertion 151 of slab-like protrusion 149 into rectangular groove 138.

In FIG. 10, during partial assembly slab-like protrusion 149 in inserted into rectangular groove 138 resulting in deformed fins 151. Friction between the deformed fins and the walls of rectangular groove 138 acts to semi-permanently hold slab-like protrusion 149 in groove 138.

In FIG. 10, second flooring element 3 with decorative surface 4 has groove 40 cut into the side of the board opposite the decorative surface. Groove 40 contains four elements arranged sequentially in the direction 30 of split-tongue entry into said groove: a converging entry region defined by sidewalls 49 and 50; a minimum width apex region defined by side wall elements 51 and 52; a diverging region defined by sidewalls 53 and 54; and a cap region defined by elements 57, 58 and 63.

In FIG. 10, during full assembly, single split-tongue 146 on half normal connector 148 mates with groove 40 in second floor board 3 to connect floor boards 1 and 3.

What is claimed is:

1. A split-tongue connector system in which the mating groove that mates with a split-tongue element said connector system comprises four regions arranged sequentially in the direction of said split-tongue tongue insertion into said mating groove:
a converging entry region having sidewalls that converge toward one another,
a minimum groove width apex region at the ends of the converging sidewalls,
a diverging hold region having sidewalls extending away from one another, and
a cap or termination region.

2. A split-tongue connector system in which one of the split-tongue elements protruding from the base support element of a lateral split-tongue connector and its mating groove are replaced by an alternative means of mechanically connecting said lateral split-tongue connector to a solid substrate element.

3. The connector system of claim 2 in which the alternative means of mechanically connecting said lateral split-tongue connector to said solid substrate element consists of a mechanical fastener such as a staple

4. The connector system of claim 2 in which the alternative means of mechanically connecting said lateral split-tongue connector to said solid entity consists of:
1. a slab-like element protruding from the base support element of said lateral split-tongue connector in a direction opposite that of the remaining split-tongue element,
2. a mating rectangular groove
3. a given amount of adhesive,
such adhesive acting to fill the gap between said slab-like element and said rectangular groove, and such adhesive acting to adhere said slab-like protrusion to the sides of said rectangular groove via said adhesive.

5. The connector system of claim 2 in which the alternative means of mechanically connecting said normal split-tongue connector to said solid entity element consists of:
1. slab-like element protruding from the base support element of said normal split-tongue connector in the same direction of the remaining split-tongue element,
2. a mating rectangular groove,
3. a given amount of adhesive;
such adhesive acting to fill the gap between said slab-like element and said rectangular groove, and such adhesive acting to adhere said slab-like protrusion to the sides of said rectangular groove via said adhesive.

6. The connector system of claim 2 in which the alternative means of mechanically connecting said lateral split-tongue connector to said solid substrate element comprising:
1. slab-like element protruding from the base support element of said normal split-tongue connector in the direction of the remaining split-tongue element,
2. a mating rectangular groove,
3. said slab-like element having one or more fin-like elements protruding laterally from both sides of said slab-like element with said fin-like elements inclined in a direction opposite the direction of insertion of the slab-like element into its mating groove;
the sides of said rectangular groove applying a lateral force to the free end of said fin-like elements causing them to bend further in a direction opposite that of said direction of insertion such that friction between the fin-like elements and the rectangular groove sidewalls acts to hold the slab-like protrusion into said rectangular groove.
